(19) United States
(12) Patent Application Publication
(10) Pub. No.: US 2025/0042229 A1
(43) Pub. Date: Feb. 6, 2025

(54) WINDSHIELD IMPROVEMENTS FOR A LOW SPEED VEHICLE

(71) Applicant: Fitz WOODROW, Charlottesville, VA (US)

(72) Inventor: Fitz WOODROW, Charlottesville, VA (US)

(21) Appl. No.: 18/788,623

(22) Filed: Jul. 30, 2024

Related U.S. Application Data
(60) Provisional application No. 63/516,964, filed on Aug. 1, 2023.

(51) Int. Cl. B60J 1/04; B60J 3/00

(52) U.S. Cl. CPC B60J 1/04; B60J 3/00

(57) ABSTRACT

Provided are windshield improvements for a low speed vehicle, such as a golf cart. The low speed vehicle windshield protects occupants from UVA and UVB rays, reduces glare, and optimizes optics of the passenger. Further, the windshield has streamline attachment methods with a new windshield profile, and vent arrangements.

### CROSS REFERENCE TO RELATED APPLICATIONS

This application claims priority to U.S. Provisional Application Ser. No. 63/516,964, filed Aug. 1, 2023, the complete disclosure of which is incorporated herein by reference in its entirety.

### BACKGROUND

There are several types of low-speed vehicles, which are typically intended for other than a highway use. Golf cars, a popular low speed vehicle, are defined under ANSI/NGCMA Z 130.1 “as a vehicle used to convey a person or persons and equipment to play the game of golf in an area designated as a golf course. To qualify as a golf cart the vehicle's average speed shall be less than (24 kin/h) 15 MPH on a horizontally level surface, 0.5% grade (0.3 degrees) comprised of a straight course composed of a concrete or asphalt surface that is dry and free from loose material or surface contamination with a minimum coefficient of friction of 0.8 between tire and surface.

The first golf car was invented in 1932. Since then, many patented improvements have been made to these low-speed vehicles. The first windshield was clear and fixed, adding a safety component by blocking the driver and passenger from wind, rain, and debris. Most often, windshields are currently formed of acrylic or polycarbonate, with acrylic being the most common. More recent versions of a windshield are a transparent fold down windshield where the windshield is fixed to the upper front struts by a rotatable hinge (5) to allow the upper portion of the windshield to fold down over the fixed lower portion. Most operators put the windshield down to allow wind though the car to keep the occupants cooler through airflow. These windshields generally use gravity to hold the windshield in the folded down position, exposing the occupants' upper body and head to stray golf balls and debris. Further, the folded down windshield offers no safety from harmful UVA and UVB rays and weather elements.

U.S. Pat. Nos. 10,493,825 and 10,596,882, by Fitz Woodrow, incorporated herein in their entirety, disclose a design wherein the low-speed vehicle windshield is configured to fold from the bottom up, providing physical protection from debris and errant golf balls, while providing air flow when in use. The cited patents envisioned adding films to the outside or inside of the windshield to improve protection to the passengers.

When the term windshield is used within the specification and claims, the term refers to a low-speed vehicle windshield, unless otherwise specified.

### SUMMARY

The objective of this invention is to give golfers a simpler, sleeker, and safer windshield for golf carts. During a round of golf in which a golf cart is used, the golfer will spend a significant amount of the time sitting in the golf cart. Therefore, making the golf cart safer is the best place to make a big difference in golfer safety.

The improvements include design features of a fold-up windshield to improve venting, UVA/UVB and anti-glare protection for the occupants of the golf car, and magnetic latch systems that are quicker, easier to rotate from a closed to open or open to closed position and provide a sleek design.

Although the disclosed design improvements are disclosed as used with a fold-up low speed vehicle windshield format, the UVA/UVB, anti-glare protection and the magnetic latches are applicable to all low-speed vehicle windshields. The disclosed invention(s) are particularly useful with a fold-up windshield design format, as the design has sufficient surface area over the occupants when folded to make the UVA and UVB protection worthwhile, in addition to enabling a sleeker design and reduced noise while the vehicle is moving. The improvements disclosed herein may be used together or separate.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front view of the low-speed vehicle windshield in the closed mode.

FIG. 2 is a front view of the low-speed vehicle windshield in the folded-up (Airflow) mode.

FIG. 3 is an illustration of the air flow.

FIG. 4 is a side view of the low-speed vehicle windshield in the folded-up (Airflow) mode.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

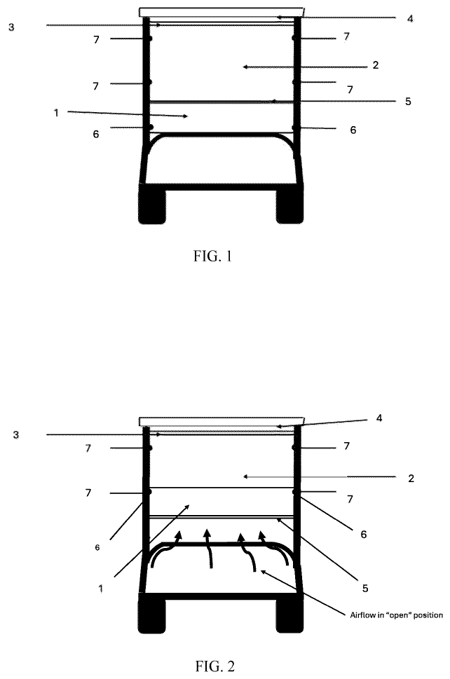

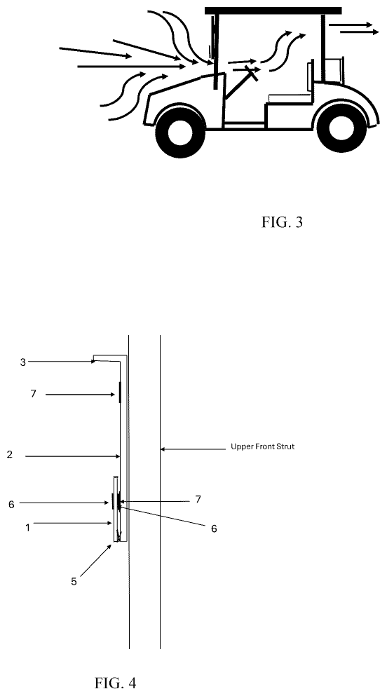

A first improvement for a low speed vehicle windshield has been developed comprising a rotatable lower windshield (1) and a fixed upper windshield (2), as shown in FIGS. 1 and 2, with an optional UVA/UVB blocking film, wherein the lower part of the windshield that folds over the upper portion is best limited to less than 30%, preferably less than 25%, alternatively limited to 15% to 20%, of the low speed vehicle total windshield height, the total windshield height being inclusive of the rotatable lower windshield (1) and the fixed upper windshield (2). When 30% or less, preferably 25% or less, of the windshield height is configured to fold up over the fixed upper windshield, a venturi effect, i.e., a substantial increase in the velocity of the air flow, is created that does not occur at the same velocity when a larger opening of the windshield is used. The air flow is shown in FIG. 3.

The low-speed vehicle windshield is bent for rigidity. At the top edge of the upper windshield, there is a portion, e.g., about 1-2 inches, of the windshield bent outward that stiffens the overall windshield. This outward stiffening bend (3) at the top edge of the windshield is found on most of all windshields for golf cars. In addition to the bend at the top edge of the windshield, the improved profile of the windshield is optionally notched at each of two sides of the bottom edge of the fixed upper windshield (2) to allow a minimal inward stiffening bend (not shown) at the bottom edge of the fixed upper windshield. The notches allow the minimal bent portion to not interfere with the upper front struts of the golf car used to mount the windshield. The notches may be 2 inches or less, preferably 1.25 inches or less from the side, for about the length of the bent portion.

Further noise reduction can be achieved by providing similar minimal inward bends on the top and/or bottom edge of the rotatable lower windshield (1). All bends are to increase rigidity and reduce rattling and/or noise of the windshield during movement of the golf car.

A second improvement is an upper vent (4) between the top of the windshield and the roof of the golf car or low speed vehicle of no more than 6 inches, preferably 3 to 0.5 inch. The upper vent at the top of the windshield works with any size fold-up portion of the windshield but works especially well with a rotatable lower windshield (1) of 30% or less of the total windshield height, alternatively 25% or less. The relatively small opening of the rotatable lower windshield (1) decreases the area for air flow during low wind conditions, e.g., while the vehicle is stopped or is at very low speed, when the venturi effect is not applicable. The upper vent at the top of the windshield will enhance the air circulation during low wind conditions by increasing the opened area and increasing air entry points. Further, the upper vent, ais designed to prevent the majority of rain entering the passenger compartment due to the overhang of the roof.

A third improvement to be described is UVA/UVB, anti-glare protection. UVA/UVB, anti-glare protection may be provided in any form, i.e., a film, a composition within the windshield, a coating applied by spray, dip or other deposition. The preferred UVA/UVB, anti-glare protection is a UVA/UVB film that provides protection from UVA/UVB wave lengths, comprises anti-glare properties, as well as providing scratch and abrasion resistance, and shards from a shattered windshield. The film is most effective on the external surface of the fixed upper windshield (2) as this is the portion that routinely protects the occupants but may also be formed on the rotatable lower windshield (1). By applying the UVA/UVB film to the external surface, the film protects the life of the windshield, but may be applied to the internal surface.

The UVA/UVB film is a low temperature and/or room temperature application film that does not require a thermal cure, with an index of refraction that is either lower or higher than, but not equal to, the windshield material, for example an index of refraction lower or higher than acrylic or polycarbonate, as applicable. The film is approximately 2 mm to 16 mm thick. The thickness can be optimized for the specific windshield, e.g., thinner for windshields formed of a more resilient material. A pre-formed UVA/UVB film, e.g., templated piece of film, is sized to fit only the flat portions of the upper windshield portion, or the bottom windshield portion. Optimally, the UVA/UVB film does not extend into stiffening bends at the top edge or bottom edge of either the fixed upper windshield and/or the rotatable lower windshield. Optimally, the UVA/UVB film does not extend into the area where the rotatable hinge (5) attaches. Although termed an edge-to-edge film, the UVA/UVB film does not extend to the sides of the windshield or any routed edge, e.g., fastener holes, or notches. Optimally, the pre-formed UVA/UVB film is sized to allow a margin of at least 0.02 inch on each routed edge of the windshield, with the preferred distance of about 0.125 inch, allowing for manufacturing tolerances. The exact distance is not critical, as long as the film does not extend exactly to or overhang the edge.

The low temperature application of the UVA/UVB film to either the fixed upper windshield or the rotatable lower windshield is after the forming and machining of the low-speed vehicle fixed upper windshield and/or rotatable lower windshield is completed. The low temperature application method includes thoroughly washing of the plastic, e.g., acrylic or polycarbonate, low speed vehicle fixed upper windshield or rotatable lower windshield prior to application of the film. Next, both the pre-formed UVA/UVB film and the fixed upper windshield and/or rotatable lower windshield are thoroughly wetted. Any protective sheets are removed from the surface of the UVA/UVB film that attaches to the fixed upper windshield and/or the rotatable lower windshield. The film is applied and adjusted in the wetted phase, while any bubbles, spaces, or contaminates, are removed from between the film and the applicable windshield. The film may be tinted or clear.

The fourth low speed vehicle windshield improvement discloses a magnetic latch system, which are part of a latch system that can reduce the noise common to golf car windshield assemblies. Previous windshields relied solely on mechanical latches, clamps or clips to maintain a rotatable windshield in place, meaning a rotatable lower windshield (1) of the instant invention, or a rotatable upper windshield of prior art. The new improvement is to rely on a double-sided magnet, pot magnet, or a series of two magnets (6) on each side of the rotatable windshield to hold the rotatable windshield open (folded) or closed (unfolded). A preferred example of a suitable double-sided magnet is male and female paired pot magnets, i.e., magnets within a housing, the male and female pair separated by the rotatable windshield. One or more double-sided magnets or magnet pairs (6) are provided on each side of the rotatable windshield.

As shown in greater detail in FIG. 4, in addition to magnets (6), the magnetic latch system comprises strike plates (7). The preferred embodiment is to have a double-sided magnet permanently mounted on the rotatable windshield (1). The positions of the strike plates (7) and the magnets (6) may be reversed, i.e., magnet (6) on the fixed windshield and the strike plate (7) on the rotatable windshield. A strike-plate is provided on the fixed windshield for the magnet to adhere. A strike plate can be incorporated into an attachment device that attaches the fixed windshield to the upper front struts. Alternatively, the strike plate (7) can be mounted to the fixed windshield separate from the attachment device of the fixed windshield. Multiple strike plates (7) can be mounted to each side of the fixed windshield. Further, as shown in FIG. 1, a strike plate (7) without a functional use can be added to the fixed upper windshield (2) for symmetry or aesthetics. To maintain a rotatable windshield in the closed position, a strike plate can be provided on the upper front strut of the golf car, or the magnet attached to the rotatable windshield can directly attach to the upper front strut if the upper front strut is formed of a material to which a magnet will attach, e.g., steel.

The magnet must be sized and of sufficient strength to hold the folding windshield portion open or closed during movement of the golf car but be sufficiently easy to release when the user wants to open or close the airflow. The magnets are especially applicable to the improved windshield wherein the folding portion is a smaller, i.e., lesser percentage of the height of the windshield, as the folding portion weighs less and is able to be securely fastened with the magnetic latch.

The latch plates and magnets may either be mounted directly over a UVA/UVB deposited coating, the UV A/UVB film, or the UVA/UVB film pre-form. Alternatively, the UVA/UVB deposited coating or UVA/UVB film may provide openings for the latch plates and magnets.

Having described the preferred aspects and implementations of the present disclosure, modifications, and equivalents of the disclosed concepts may readily occur to one skilled in the art. However, it is intended that such modifications and equivalents be included within the scope of the claims which are appended hereto.

What is claimed is:

1. A windshield for a golf car, personal transport vehicle or a low speed vehicle, the windshield comprising:
an upper windshield;
a bottom windshield;
a rotatable device attaching the upper windshield to the bottom windshield;
wherein one of the upper windshield or the bottom windshield is a fixed windshield attached to the upper front struts and the other of the upper windshield or bottom windshield is a rotatable windshield;
wherein the rotatable windshield includes one or more magnets that are configured to latch itself in a folded position over the fixed windshield; and
wherein the fixed windshield comprises strike plates configured to adhere to the magnets when the movable windshield is in the folded position.

2. The windshield of claim 1, wherein the magnetic attachment devices are selected from double-sided magnets, pot magnets, or two magnets fixed on opposite surfaces of the rotatable windshield.

3. The windshield of claim 1, wherein the bottom windshield folds over the upper windshield portion.

4. The windshield of claim 3, wherein the bottom windshield is 25% or less of the total windshield height.

5. The windshield of claim 1, wherein there exists a space between the top of the windshield and the roof of the golf cart, personal transport vehicle or a low speed vehicle.

6. The windshield of claim 5, wherein the space is 0.5-3 inches.

7. The windshield of claim 1, further comprising UVA/UVB anti-glare protection, wherein the UVA/UVB anti-glare protection is included integrally in the material of the windshield, formed on the external surface of the windshield, or formed on the internal surface of the windshield.

8. The windshield of claim 7, wherein the UVA/UVB anti-glare protection is a film formed on the external surface of the upper windshield.

9. The windshield of claim 1, wherein the strike plate can be incorporated into an attachment device that attaches the fixed windshield to the upper front struts.

10. A process for forming a windshield according to claim 8, the process steps comprising:
forming an upper windshield and a lower windshield;
forming a templated UVA/UVB film that follows the outline of the machined upper windshield;
wherein the templated UVA/UVB film is slightly smaller than the windshield edges;
wetting both the windshield and the UVA/UVB film prior to fitting the template onto the windshield; and
applying the templated UVA/UVB film to the windshield in the wetted stage, removing bubbles, wrinkles, and air gaps.

11. A vehicle comprising:
a support structure on the front of the vehicle;
a windshield of claim 1 comprising a fixed windshield and a rotatable windshield; and
wherein the fixed windshield is mounted to the support structure.

12. The vehicle of claim 11, wherein the vehicle is a golf car, and
the fixed windshield is mounted to the upper struts of the golf car.
